(19) United States
(12) Patent Application Publication
(10) Pub. No.: US 2023/0406303 A1
(43) Pub. Date: Dec. 21, 2023

(54) VEHICLE CONTROL DEVICE, CONTROL METHOD FOR A VEHICLE CONTROL DEVICE, AND NON-TRANSITORY COMPUTER-READABLE STORAGE MEDIUM STORING A CONTROL PROGRAM FOR A VEHICLE CONTROL DEVICE

(71) Applicant: TOYOTA JIDOSHA KABUSHIKI KAISHA, Toyota-shi (JP)

(72) Inventor: Keigo OISHI, Toyota-shi (JP)

(73) Assignee: TOYOTA JIDOSHA KABUSHIKI KAISHA, Toyota-shi (JP)

(21) Appl. No.: 18/143,698

(22) Filed: May 5, 2023

(30) Foreign Application Priority Data
Jun. 16, 2022 (JP) 2022-097651

(51) Int. Cl. B60W 30/165; B60W 40/12; B60W 10/18; B60W 10/04

(52) U.S. Cl. CPC B60W 30/165; B60W 40/12; B60W 2520/14; B60W 10/04; B60W 2520/28; B60W 10/18

(57) ABSTRACT

A vehicle control device applied to connected vehicles in which a towed vehicle is connected to a towing vehicle, including: a braking and driving section; a braking and driving force detection section; a mass estimation section to estimate a mass of the towed vehicle; an angle detection section to detect a bending angle of a connecting section between the towing vehicle and the towed vehicle; a yaw moment estimation section to estimate a yaw moment with respect to the towing vehicle during braking of the towing vehicle; a calculation section to calculate a left-right difference in braking force of the towing vehicle so as to suppress the yaw moment; and a control section to control left and right braking forces of the towing vehicle, by using a detection result of the braking and driving force detection section, based on a calculation result of the calculation section.

### CROSS-REFERENCE TO RELATED APPLICATION

This application is based on and claims priority under 35 USC 119 from Japanese Patent Application No. 2022-097651 filed on Jun. 16, 2022, the disclosure of which is incorporated by reference herein.

### BACKGROUND

### Technical Field

The present disclosure relates to a vehicle control device, a control method for a vehicle control device, and a control program for a vehicle control device.

### Related Art

Japanese Patent Application Laid-Open (JP-A) No. 2001-278019 discloses a braking force control device for connected vehicles. To explain in brief, this braking force control device is provided with means for obtaining a total braking force corresponding to a brake operation amount, and means for performing control so as to raise a distribution ratio of the total braking force to a towed vehicle during braking during downhill travel to higher than a reference value on a flat road by a ratio corresponding to a downhill gradient. In this braking force control device, by raising the distribution ratio of the total braking force to the towed vehicle during downhill braking, occurrence of a jackknife phenomenon on a downhill road is suppressed.

However, even when not on a downhill road, there are cases in which the jackknife phenomenon occurs when a towing vehicle is braked in a state in which a connecting section between the towing vehicle and the towed vehicle is bent at a bending angle, and therefore, there is room for improvement with respect to the related art described above.

### SUMMARY

In consideration of the above facts, an object of the present disclosure is to provide a vehicle control device, a control method for a vehicle control device, and a non-transitory computer-readable storage medium storing a control program for a vehicle control device that are capable of suppressing occurrence of a jackknife phenomenon even when a towing vehicle is braked in a state in which a connecting section between the towing vehicle and a towed vehicle is bent at a bending angle.

A vehicle control device according to a first aspect of the present disclosure is applied to connected vehicles in which a towed vehicle is connected to a towing vehicle, the vehicle control device including: a braking and driving section configured to independently apply braking and driving forces to left and right wheels of the towing vehicle, respectively; a braking and driving force detection section configured to detect braking and driving forces of respective wheels of the towing vehicle; a mass estimation section configured to estimate a mass of the towed vehicle; an angle detection section configured to detect a bending angle of a connecting section between the towing vehicle and the towed vehicle; a yaw moment estimation section configured to estimate a yaw moment with respect to the towing vehicle during braking of the towing vehicle, using a detection result of the angle detection section and an estimation result of the mass estimation section; a calculation section configured to calculate a left-right difference in braking force of the towing vehicle so as to suppress the yaw moment estimated by the yaw moment estimation section; and a control section configured to control left and right braking forces of the towing vehicle, by using a detection result of the braking and driving force detection section, based on a calculation result of the calculation section.

It should be noted that the “braking and driving forces” of the first aspect of the present disclosure refer to forces that accelerate and decelerate the towing vehicle, and include both braking forces that decelerate the towing vehicle and driving forces that accelerate the towing vehicle (hereinafter, the same applies in the present specification). Further, in a case in which an object or the like is loaded at the towed vehicle, the “mass of the towed vehicle” of the first aspect of the present disclosure refers to a mass of the towed vehicle in a state in which the object or the like is loaded (the same applies in the present specification).

According to the above configuration, the vehicle control device is applied to the connected vehicles in which the towed vehicle is connected to the towing vehicle, and the braking and driving section independently applies braking and driving forces to the left and right wheels of the towing vehicle, respectively. Further, the braking and driving force detection section detects the braking driving forces of the respective wheels of the towing vehicle, the mass estimation section estimates the mass of the towed vehicle, and the angle detection section detects the bending angle of the connecting section between the towing vehicle and the towed vehicle. Moreover, the yaw moment estimation section estimates the yaw moment with respect to the towing vehicle during braking of the towing vehicle, using the detection result of the angle detection section and the estimation result of the mass estimation section. The calculation section calculates the left-right difference in braking force of the towing vehicle so as to suppress the yaw moment estimated by the yaw moment estimation section. The control section uses the detection result of the braking and driving force detection section to control the left and right braking forces of the towing vehicle, based on the calculation result of the calculation section. Consequently, the bending angle of the connecting section between the towing vehicle and the towed vehicle can be controlled during braking of the towing vehicle, and it is possible to suppress occurrence of a jackknife phenomenon.

A vehicle control device according a second aspect of the present disclosure is the vehicle control device according to the first aspect, which includes a wheel speed detection section configured to detect respective wheel speeds of the towing vehicle, wherein the calculation section calculates a target total braking force based on a detection result of the wheel speed detection section and a travel plan of the towing vehicle, and calculates the left and right braking forces of the towing vehicle without changing the target total braking force when calculating the left-right difference in braking force of the towing vehicle so as to suppress the yaw moment estimated by the yaw moment estimation section.

According to the above configuration, the wheel speed detection section detects the respective wheel speeds of the towing vehicle, and the calculation section calculates the target total braking force based on the detection result of the wheel speed detection section and the travel plan of the towing vehicle. Further, when calculating the left-right difference in braking force of the towing vehicle so as to suppress the yaw moment estimated by the yaw moment estimation section, the calculation section calculates the left and right braking forces of the towing vehicle without changing the target total braking force. As a result, the bending angle of the connecting section between the towing vehicle and the towed vehicle can be controlled while braking with the target total braking force.

A vehicle control device according to a third aspect of the present disclosure is the vehicle control device according to the first aspect or the second aspect, wherein the control section controls the left and right braking forces of the towing vehicle such that a change gradient, which is a change amount per unit time of each of the left and right braking forces of the towing vehicle, does not exceed a preset upper limit gradient.

According to the above configuration, the control section controls the left and right braking forces of the towing vehicle such that the change gradient, which is the change amount per unit time of each of the left and right braking forces of the towing vehicle, does not exceed the preset upper limit gradient. As a result, abrupt generation of an anti-yaw moment, which is a force in an opposite direction to the yaw moment with respect to the towing vehicle, can be suppressed, enabling the towing vehicle to travel stably.

A control method for a vehicle control device according to a fourth aspect of the present disclosure is a control method for a vehicle control device that is applied to connected vehicles in which a towed vehicle is connected to a towing vehicle, wherein the vehicle control device includes: a braking and driving section configured to independently apply braking and driving forces to left and right wheels of the towing vehicle, respectively; a braking and driving force detection section configured to detect braking and driving forces of respective wheels of the towing vehicle; a mass estimation section configured to estimate a mass of the towed vehicle; and an angle detection section configured to detect a bending angle of a connecting section between the towing vehicle and the towed vehicle, and wherein the control method includes: estimating a yaw moment with respect to the towing vehicle during braking of the towing vehicle, using a detection result of the angle detection section and an estimation result of the mass estimation section; calculating a left-right difference in braking force of the towing vehicle so as to suppress the estimated yaw moment; and controlling left and right braking forces of the towing vehicle, by using a detection result of the braking and driving force detection section, based on a calculation result of calculating the left-right difference in braking force. Consequently, similarly to the disclosure of the first aspect, the bending angle of the connecting section between the towing vehicle and the towed vehicle can be controlled during braking of the towing vehicle, and it is possible to suppress occurrence of a jackknife phenomenon.

A control program for a vehicle control device according to a fifth aspect of the present disclosure is executable by a computer included in the vehicle control device to perform processing, wherein the vehicle control device is applied to connected vehicles in which a towed vehicle is connected to a towing vehicle, and the vehicle control device includes: a braking and driving section configured to independently apply braking and driving forces to left and right wheels of the towing vehicle, respectively; a braking and driving force detection section configured to detect braking and driving forces of respective wheels of the towing vehicle; a mass estimation section configured to estimate a mass of the towed vehicle; and an angle detection section configured to detect a bending angle of a connecting section between the towing vehicle and the towed vehicle, and wherein the processing includes: estimating a yaw moment with respect to the towing vehicle during braking of the towing vehicle, using a detection result of the angle detection section and an estimation result of the mass estimation section; calculating a left-right difference in braking force of the towing vehicle so as to suppress the estimated yaw moment; and controlling left and right braking forces of the towing vehicle, by using a detection result of the braking and driving force detection section, based on a calculation result of calculating the left-right difference in braking force. Consequently, due to the computer executing the control program for a vehicle control device according to the disclosure of the fifth aspect, the control method for a vehicle control device of the fourth aspect is implemented by the computer, and similarly to the disclosure of each of the first aspect and the fourth aspect, the bending angle of the connecting section between the towing vehicle and the towed vehicle can be controlled during braking of the towing vehicle, and it is possible to suppress occurrence of a jackknife phenomenon.

As described above, the present disclosure exhibits the excellent advantageous effect of enabling suppression of occurrence of a jackknife phenomenon even when the towing vehicle is braked in a state in which the connecting section between the towing vehicle and the towed vehicle is bent at a bending angle.

### BRIEF DESCRIPTION OF THE DRAWINGS

An exemplary embodiments of the present invention will be described in detail based on the following figures, wherein:

FIG. 1 is a simplified perspective view illustrating a schematic configuration of connected vehicles installed with a vehicle control device according to an exemplary embodiment;

FIG. 2 is a block diagram illustrating an example of a hardware configuration of the vehicle control device of FIG. 1;

FIG. 3 is a block diagram illustrating an example of a functional configuration of an ECU of the vehicle control device of FIG. 1;

FIG. 4 is a flowchart illustrating an example of a flow of travel control processing performed by the ECU of the vehicle control device of FIG. 1;

FIG. 5 is a schematic plan view for explaining a bending angle in a connecting section of the connected vehicles of FIG. 1 and a distance between an axle of a towing vehicle and a connecting point;

FIG. 6 is a schematic plan view illustrating a state before the towing vehicle is braked in a state in which the connecting section of the connected vehicles of FIG. 1 is bent at a bending angle;

FIG. 7 is a schematic plan view illustrating a state in which the towing vehicle is braked in a state in which the connecting section of the connected vehicles is bent at a bending angle, in the vehicle control device of FIG. 1; and

FIG. 8 is a schematic plan view illustrating a state in which a towing vehicle is braked in a state in which a connecting section of connected vehicles is bent at a bending angle, in a comparative example.

### DETAILED DESCRIPTION

A vehicle control device, a control method for a vehicle control device, and a control program for a vehicle control device according to an exemplary embodiment of the present disclosure will be explained with reference to the drawings.

### Configuration of Exemplary Embodiment

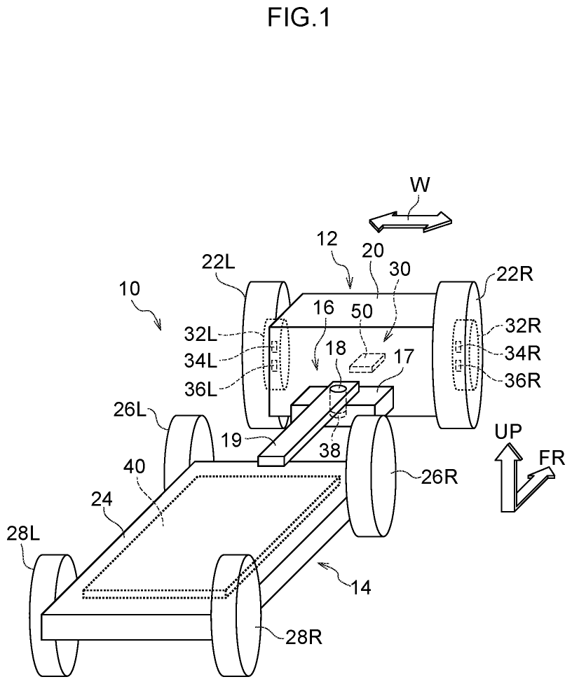

In FIG. 1, a schematic configuration of connected vehicles 10 installed with a vehicle control device 30 according to the present exemplary embodiment is illustrated in a simplified perspective view. As illustrated in FIG. 1, the vehicle control device 30 is applied to the connected vehicles 10 in which a towed vehicle 14 is connected to a towing vehicle 12. It should be noted that arrow FR illustrated in FIG. 1 indicates a vehicle front side, arrow UP indicates a vehicle upper side, and arrow W indicates a vehicle width direction.

The towing vehicle 12 illustrated in FIG. 1 is an autonomous driving vehicle, and, as an example, travels within a factory to be used for transportation of components and the like. The towing vehicle 12 includes a vehicle body 20 and wheels 22L, 22R arranged at the left and right of the vehicle body 20, and does not include a steering mechanism. The left and right wheels 22L, 22R are each independently rotatable drive wheels, and are configured so as not to be able to change angles thereof with respect to the vehicle body 20 in plan view.

Further, the towing vehicle 12 is provided with in-wheel motors (also referred to as “in-wheel motors”) 32L, 32R serving as a braking and driving section that independently applies braking and driving forces to the left and right wheels 22L, 22R of the towing vehicle 12, respectively. The in-wheel motors 32L, 32R are configured to be capable of outputting torque. The left in-wheel motor 32L is provided at the left wheel 22L so as to be able to drive the left wheel 22L in a forward rotation direction and a reverse rotation direction, and the right in-wheel motor 32R is provided at the right wheel 22R so as to be able to drive the right wheel 22R in a forward rotation direction and a reverse rotation direction. The left and right in-wheel motors 32L, 32R are independently controllable, and turning operation of the towing vehicle 12 can be controlled by providing a difference in torque between the left and right in-wheel motors 32L, 32R. Furthermore, braking and driving operation of the towing vehicle 12 can be controlled by changing rotational speeds of the in-wheel motors 32L, 32R.

Further, the towing vehicle 12 is provided with wheel speed sensors 34L, 34R serving as a wheel speed detection section that detects respective wheel speeds (rotational speeds of the respective wheels 22L, 22R) of the towing vehicle 12. The left wheel speed sensor 34L detects the rotational speed of the left wheel 22L, and the right wheel speed sensor 34R detects the rotational speed of the right wheel 22R. Furthermore, the towing vehicle 12 is provided with torque sensors 36L, 36R that detect torques of the respective wheels 22L, 22R of the towing vehicle 12. The left torque sensor 36L detects the torque of the left wheel 22L, and the right torque sensor 36R detects the torque of the right wheel 22R.

The towed vehicle 14 connected to the towing vehicle 12 includes a loading platform 24, wheels 26L, 26R arranged at the left and right of a front portion of the loading platform 24, and wheels 28L, 28R arranged at the left and right of a rear portion of the loading platform 24. A load sensor (also referred to as a “mass sensor”) 40 that detects a mass of a load (not illustrated in the drawings) loaded at the loading platform 24 is provided at the loading platform 24 of the towed vehicle 14.

Further, a connecting section 16 between the towing vehicle 12 and the towed vehicle 14 is configured to include a hitch 17 provided at a towing vehicle 12 side, a bracket 19 provided at a towed vehicle 14 side, and a connecting shaft 18 connecting the hitch 17 and the bracket 19. The hitch 17 is fixed at a vehicle width direction central portion at a rear end portion of the vehicle body 20 of the towing vehicle 12, and extends toward a vehicle body rear side. The bracket 19 is fixed at a vehicle width direction central portion at a front end portion of the loading platform 24 of the towed vehicle 14, and extends toward a vehicle body front side. The connecting shaft 18 is arranged with an axial direction thereof being an up-down direction, and connects the hitch 17 and the bracket 19 so as to be rotatable about an axis in the up-down direction.

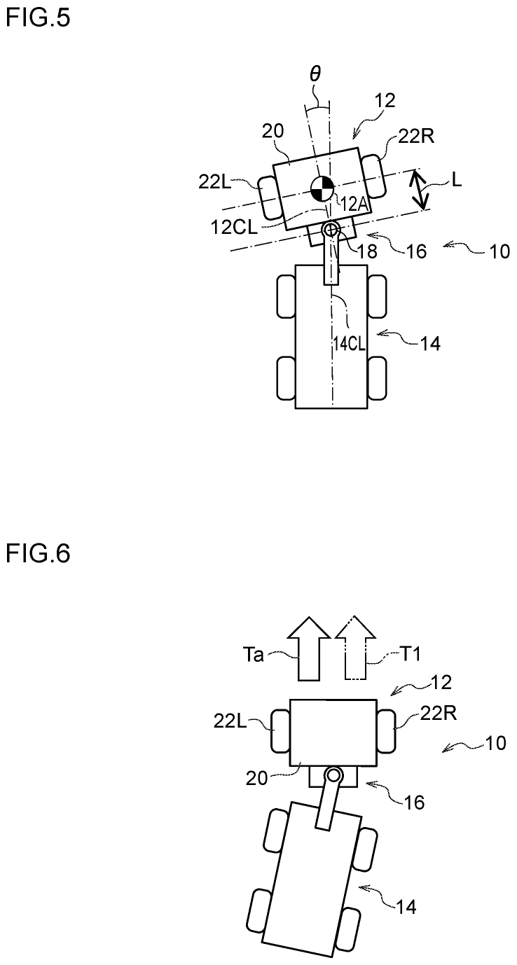

The connecting section 16 is provided with a rotation angle sensor 38 serving as an angle detection section that detects a bending angle of the connecting section 16 between the towing vehicle 12 and the towed vehicle 14. It should be noted that the bending angle of the connecting section 16 between the towing vehicle 12 and the towed vehicle 14 refers to a bending angle θ of a vehicle width direction centerline 12CL of the towing vehicle 12 with respect to a vehicle width direction centerline 14CL of the towed vehicle 14, as illustrated in FIG. 5.

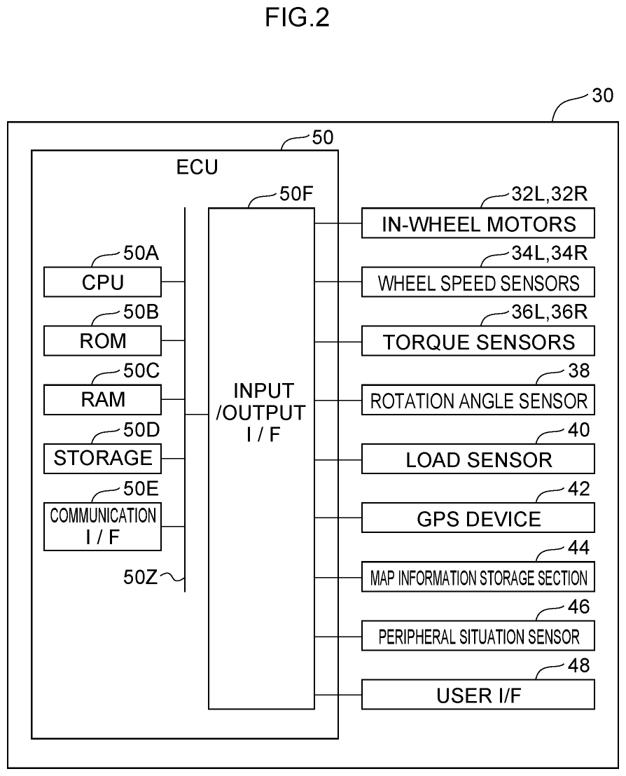

In FIG. 2, an example of a hardware configuration of the vehicle control device 30 according to the present exemplary embodiment is illustrated in a block diagram. As illustrated in FIG. 2, the vehicle control device 30 includes the in-wheel motors 32L, 32R, the wheel speed sensors 34L, 34R, the torque sensors 36L, 36R, the rotation angle sensor 38, and the load sensor 40 described above, as well as a global positioning system (GPS) device 42, a map information storage section 44, a peripheral situation sensor 46, a user interface (abbreviated as “USER I/F” in FIG. 2) 48, and an electrical control unit (ECU) 50 serving as a computer.

The GPS device 42 acquires a current position of the connected vehicles 10. The map information storage section 44 stores a map database. The peripheral situation sensor 46 detects a peripheral situation around the connected vehicles 10. The peripheral situation sensor 46 includes, for example, a radar that detects a preceding vehicle traveling at a forward side in a travel direction of the towing vehicle 12 or the like, and a camera that captures peripheral information of the connected vehicles 10.

The user interface 48 is an interface that is used when a user uses the vehicle control device 30. The user interface 48 includes, for example, at least one of a liquid crystal display including a touch panel that enables touch operation by the user, or a voice input receiving section that receives voice input by the user.

The ECU 50 performs travel control processing for autonomous driving to cause the towing vehicle 12 to travel autonomously. The ECU 50 is configured to include a central processing unit (CPU; processor) 50A, a read only memory (ROM) 50B, a random access memory (RAM) 50C, a storage 50D, a communication interface (abbreviated as “COMMUNICATION I/F” in FIG. 2) 50E, and an input/output interface (abbreviated as “INPUT/OUTPUT I/F” in FIG. 2). The CPU 50A, the ROM 50B, the RAM 50C, the storage 50D, the communication interface 50E, and the input/output interface 50F are connected so as to be capable of communicating with each other via a bus 50Z.

The CPU 50A is a central arithmetic processing unit, and the CPU 50A executes various programs and controls various sections. Namely, the CPU 50A reads out programs from the ROM 50B or the storage 50D, and executes the programs using the RAM 50C as a workspace. The CPU 50A carries out control of the aforementioned respective configurations and various kinds of arithmetic processing according to the programs recorded in the ROM 50B or the storage 50D.

The ROM 50B stores various programs and various data. The RAM 50C serves as a workspace to temporarily store programs and data. The storage 50D is configured by a storage device such as a hard disk drive (HDD), a solid state drive (SSD) or the like, and stores various programs and various data. It should be noted that data stored in a predetermined area of the storage 50D is updatable using the user interface 48. Further, in the present exemplary embodiment, a travel control program for autonomous driving (an example of the control program for a vehicle control device according to the present disclosure) is stored in the ROM 50B or the storage 50D.

The communication interface 50E is an interface for communicating with other devices, such as a portable terminal (not illustrated in the drawings) or the like. For example, a wireless communication standard such as 4G, 5G, Wi-Fi (registered trademark) or the like is used for this communication.

The input/output interface 50F is an interface for communicating with respective devices installed at the connected vehicles 10. The ECU 50 of the present exemplary embodiment is connected to, as an example, the in-wheel motors 32L, 32R, the wheel speed sensors 34L, 34R, the torque sensors 36L, 36R, the rotation angle sensor 38, the load sensor 40, the GPS device 42, the map information storage section 44, the peripheral situation sensor 46, and the user interface 48 through the input/output interface 50F. It should be noted that the in-wheel motors 32L, 32R, the wheel speed sensors 34L, 34R, the torque sensors 36L, 36R, the rotation angle sensor 38, the load sensor 40, the GPS device 42, the map information storage section 44, the peripheral situation sensor 46, and the user interface 48 may be directly connected to the bus 50Z.

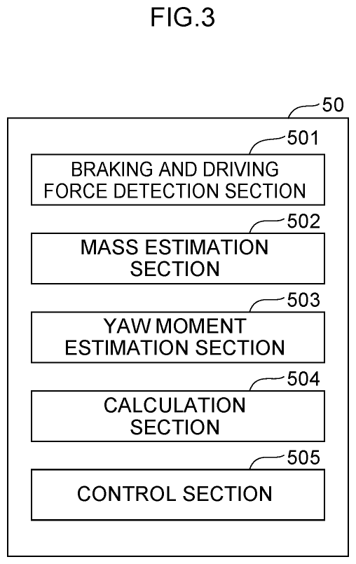

In FIG. 3, an example of a functional configuration of the ECU 50 is illustrated in a block diagram. As illustrated in FIG. 3, the ECU 50 includes functional configuration including a braking and driving force detection section 501, a mass estimation section 502, a yaw moment estimation section 503, a calculation section 504, and a control section 505. The respective functional configuration is implemented by the CPU 50A reading out and executing a program (the travel control program for autonomous driving described above) stored in the ROM 50B or the storage 50D.

The braking and driving force detection section 501 detects braking and driving forces of the respective wheels 22L, 22R of the towing vehicle 12. The braking and driving force detection section 501 divides a detection value from the left torque sensor 36L by a tire radius (dynamic load radius) of the left wheel 22L to detect the braking and driving force of the left wheel 22L, and divides a detection value from the right torque sensor 36R by a tire radius (dynamic load radius) of the right wheel 22R to detect the braking and driving force of the right wheel 22R. The tire radii (dynamic load radii) of the wheels 22L, 22R are stored in advance in the ROM 50B or the storage 50D.

The mass estimation section 502 estimates a mass of the towed vehicle 14. The mass estimation section 502 adds a detection value from the load sensor 40 to a mass of the towed vehicle 14 in a state in which no load is loaded, to estimate the mass of the towed vehicle 14. The mass of the towed vehicle 14 in the state in which no load is loaded is stored in advance in the ROM 50B or the storage 50D.

The yaw moment estimation section 503 estimates a yaw moment with respect to the towing vehicle 12 during braking of the towing vehicle 12, using a detection result from the rotation angle sensor 38 and an estimation result from the mass estimation section 502. The calculation section 504 calculates a left-right difference in braking force of the towing vehicle 12 so as to suppress the yaw moment estimated by the yaw moment estimation section 503. Further, based on detection results from the wheel speed sensors 34L, 34R and a travel plan of the towing vehicle 12, the calculating section 504 calculates a target total braking force, and, when calculating the left-right difference in braking force of the towing vehicle 12 so as to suppress the yaw moment estimated by the yaw moment estimation section 503, calculates left and right braking forces of the towing vehicle 12 without changing the target total braking force.

Based on a calculation result of the calculation section 504, the control section 505 uses a detection result from the braking and driving force detection section 501 to control the left and right braking forces of the towing vehicle 12. Further, the control section 505 controls the left and right braking forces of the towing vehicle 12 so that a change gradient, which is a change amount per unit time of each of the left and right braking forces of the towing vehicle 12, does not exceed a preset upper limit gradient.

### Operation and Effects of Exemplary Embodiment

Next, operation of the vehicle control device 30 will be explained.

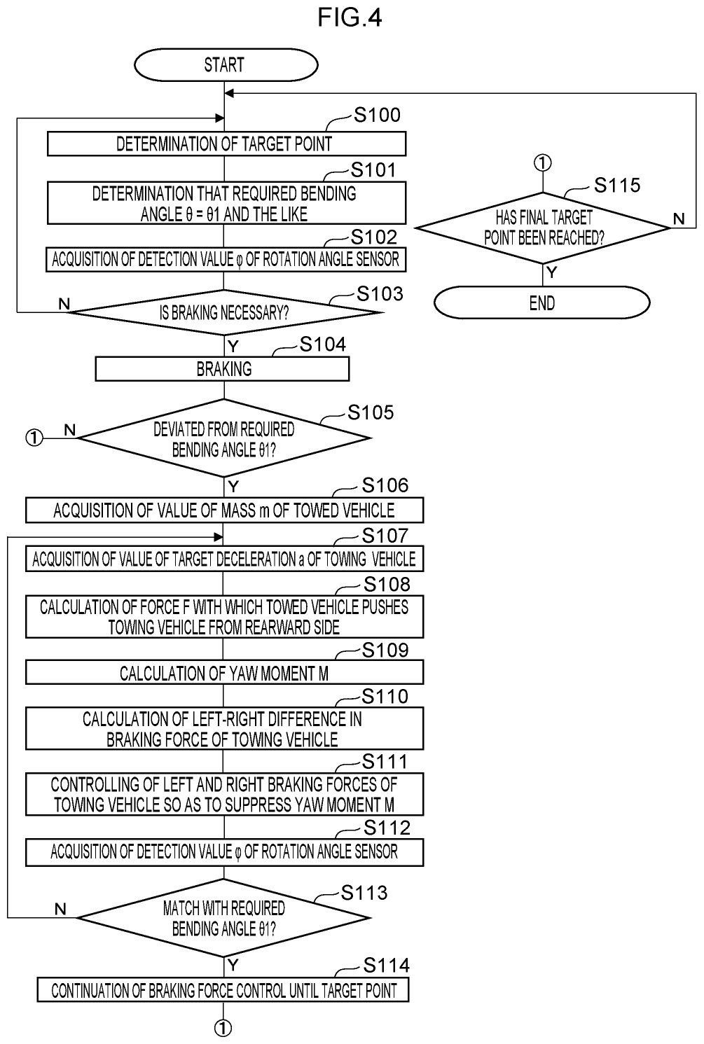

In FIG. 4, an example of a flow of travel control processing performed by the ECU is illustrated in a flow chart. The travel control processing performed by the ECU 50 is performed by the CPU 50A reading out the travel control program from the ROM 50B or the storage 50D, and expanding and executing the travel control program in the RAM 50C. For example, in a case in which the CPU 50A of the ECU 50 that has received a command to start travel of the towing vehicle 12 causes the towing vehicle 12 to travel by driving forces of the in-wheel motors 32L, 32R, execution of the control processing illustrated in FIG. 4 is started.

First, based on travel plan information stored in, for example, the storage 50D, the CPU 50A determines an immediate target point for movement (step S100). It should be noted that the immediate target point is a point on a course of the travel plan.

Next, based on information of the target point that has been determined at step S100, the CPU 50A determines that a required bending angle θ (refer to FIG. 5) of the towing vehicle 12 is set to θ1, and controls driving of the in-wheel motors 32L, 32R so that the required bending angle θ of the towing vehicle 12 becomes equal to θ1 (step S101). It should be noted that θ1=0[° ] in a case in which the towing vehicle 12 travels straight, and that |θ1|>0[° ] in a case in which the towing vehicle 12 turns. To provide supplementary explanation regarding a case in which the towing vehicle 12 turns, in a case in which it is necessary to turn at a target turning trajectory in order to reach the target point, a turning center and a turning radius are uniquely determined, and the required bending angle can be determined.

Next, the CPU 50A acquires a detection value φ of the rotation angle sensor 38 (step S102). Next, the CPU 50A determines whether or not it is necessary to brake the towing vehicle 12 (step S103). In a case in which there is no need to brake the towing vehicle 12 (step S103: N), the CPU 50A returns to the processing of step S100. In a case in which it is necessary to brake the towing vehicle 12 (step S103: Y), the CPU 50A controls the in-wheel motors 32L, 32R to thereby brake the towing vehicle 12 at step S104. Next, the CPU 50A determines whether or not the detection value φ of the rotation angle sensor 38 is deviated from the required bending angle θ1 (namely, whether or not |θ1−φ|>0[° ]) (step S105).

In a case in which the detection value φ of the rotation angle sensor 38 is not deviated from the required bending angle θ1 (step S105: N), the CPU 50A transitions to the processing of step S115 (which will be described later). In a case in which the detection value φ of the rotation angle sensor 38 is deviated from the required bending angle θ1 (step S105: Y), the CPU 50A acquires a value of a mass m of the towed vehicle 14 in a state in which a load has been loaded, at step S106. Namely, at step S106, the CPU 50A adds a detection value from the load sensor 40 to a mass of the towed vehicle 14 in a state in which no load is loaded, to acquire an estimated value of the mass m of the towed vehicle 14 in a state in which the load has been loaded.

Next, the CPU 50A acquires a value of a target deceleration (target negative acceleration) a of the towing vehicle 12 (step S107). It should be noted that the CPU 50A calculates the target deceleration a based on information including the detection results from the wheel speed sensors 34L, 34R and the respective position information of a current point and the target point of the towing vehicle 12. Incidentally, it should be noted that a travel plan distance from the current point to the target point of the towing vehicle 12 can be calculated from the respective position information of the current point and the target point of the towing vehicle 12.

Next, based on the value acquired at step S106 (the value of the mass m of the towed vehicle 14 in a state in which a load has been loaded) and the value acquired at step S107 (the value of the target deceleration a of the towing vehicle 12), the CPU 50A calculates a force F with which the towed vehicle 14 pushes the towing vehicle 12 from a rearward side due to deceleration of the towing vehicle 12 using the formula F=m×a (step S108).

Next, based on the value calculated at step S108 (the value of the force F with which the towed vehicle 14 pushes the towing vehicle 12 from the rearward side) and a distance L (refer to FIG. 5) between an axle of the towing vehicle 12 and a center (connecting point) of the connecting shaft 18, the CPU 50A calculates a yaw moment (also referred to as a “spin moment”) M from the formula M=F×L (step S109). In other words, the CPU 50A estimates the yaw moment M.

Next, the CPU 50A calculates the left-right difference in braking force of the towing vehicle 12 so as to suppress the yaw moment M calculated at step S109 (step S110). Here, based on the detection results from the wheel speed sensors 34L, 34R and the travel plan of the towing vehicle 12, the CPU 50A calculates the target total braking force corresponding to the target deceleration, and, when calculating the left-right difference in braking force of the towing vehicle 12 so as to suppress the yaw moment M, calculates the left and right braking forces of the towing vehicle 12 without changing the target total braking force.

Next, based on a calculation result at step S110, the CPU 50A controls the left and right braking forces of the towing vehicle 12 so as to suppress the yaw moment M (step S111). In other words, at step S111, the CPU 50A generates a regenerative braking force so as to generate a force in an opposite direction to the yaw moment M. Consequently, the bending angle θ of the connecting section 16 between the towing vehicle 12 and the towed vehicle 14 can be controlled during braking of the towing vehicle 12, and it becomes possible to suppress occurrence of a jackknife phenomenon.

Further, at step S111, the CPU 50A controls the right and left braking forces of the towing vehicle 12 so that the change gradient, which is the change amount per unit time of each of the left and right braking forces of the towing vehicle 12, does not exceed the preset upper limit gradient. To provide supplementary explanation, in the present exemplary embodiment, in a case in which the change gradient exceeds the upper limit gradient, the CPU 50A limits the change gradient so as to become the upper limit gradient, and controls the left and right braking forces of the towing vehicle 12 so as to gradually approach the left-right difference in braking force calculated at step S110. This enables abrupt generation of an anti-yaw moment, which is a force in an opposite direction to the yaw moment M with respect to the towing vehicle 12, to be suppressed, enabling the towing vehicle 12 to travel stably.

Next, the CPU 50A acquires the detection value φ of the rotation angle sensor 38 (step S112). Then, the CPU 50A determines whether or not the detection value φ of the rotation angle sensor 38 matches the required bending angle θ1 (namely, whether or not |θ1−φ|=0[° ]) (step S113).

In a case in which the detection value φ of the rotation angle sensor 38 does not match the required bending angle θ1 (step S113: N), the CPU 50A returns to the processing of step S107. In a case in which the detection value φ of the rotation angle sensor 38 matches the required bending angle θ1 (step S113: Y), at step S114, the CPU 50A continues to control the left and right braking forces of the towing vehicle 12 until the target point, and transitions to the processing of step S115.

At step S115, the CPU 50A determines whether or not a final target point has been reached. In a case in which the final target point has not been reached (step S115: N), the CPU 50A returns to the processing of step S100. In a case in which the final target point has been reached (step S115: Y), the CPU 50A ends the processing based on the travel control program.

Supplementary explanation follows regarding control of the bending angle θ of the connecting section 16 illustrated in FIG. 5, with reference to FIG. 6 to FIG. 8, which are schematic plan views. It should be noted that, in FIG. 8, behavior of connected vehicles 100 according to a comparative example is illustrated. Further, examples of cases in which the connecting sections 16, 116 of the connected vehicles 10, 100 are bent at a bending angle in plan view include a time of turning, a time of traveling on a super-elevation road (particularly in a case in which a loaded mass of the towed vehicle is large), a time of traveling downhill, and the like.

First, in a case in which the towing vehicle 12 travels on a flat road or an upward slope while maintaining a constant speed or accelerating in a direction of a target trajectory T1 with the same driving forces for the left and right in a state in which the connecting section 16 of the connected vehicles 10 is bent at a bending angle as illustrated in FIG. 6, a force that pushes the towing vehicle 12 from a towed vehicle 14 side is not exerted. Accordingly, a direction of an actual trajectory Ta of the towing vehicle 12 is the same direction as the direction of the target trajectory T1. In a case in which the direction of the target trajectory T1 of the towing vehicle 12 and the direction of the actual trajectory Ta are the same direction as each other in this manner, there is no need to take measures to control the bending angle of the connecting section.

On the other hand, in a case in which braking forces of the same force for the left and right are generated in the towing vehicle 112 traveling in a state in which the connecting section 116 of the connected vehicles 100 of the comparative example is bent at a bending angle as illustrated in FIG. 8, the towing vehicle 112 decelerates, but the pulled vehicle 114 attempts to move inertially toward a forward side thereof. Consequently, a force that pushes from the towed vehicle 114 side is exerted on the towing vehicle 112, and a yaw moment (refer to arrow M) that attempts to rotate the towing vehicle 112 about a center of gravity 112A thereof is generated. As a result, the towing vehicle 112 faces further toward a left side than a direction of a target trajectory T3, and therefore, an actual trajectory Tc of the towing vehicle 112 deviates from the target trajectory T3.

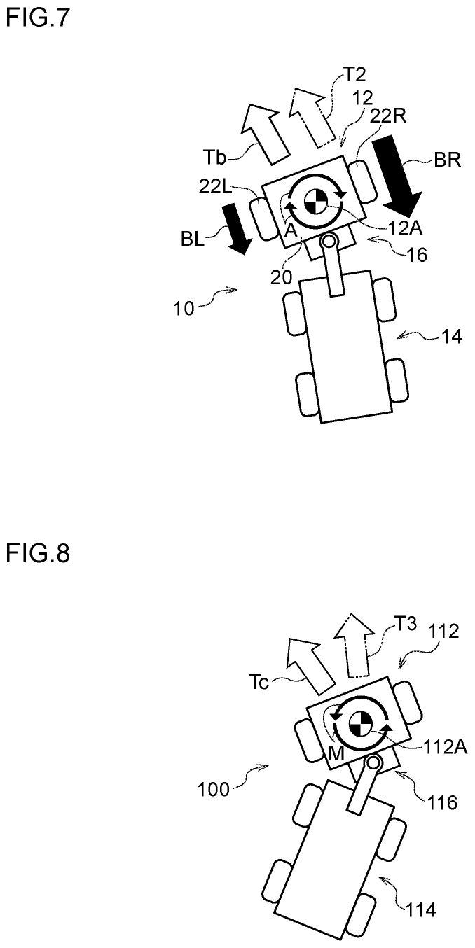

In contrast, in the present exemplary embodiment, as illustrated in FIG. 7, in a case in which the towing vehicle 12 traveling in a state in which the connecting section 16 of the connected vehicles 10 is bent at a bending angle generates braking force and deviates from a target trajectory T2, the left and right wheels 22L, 22R are controlled so that an anti-yaw moment (refer to arrow A) about a center of gravity 12A can be generated. Namely, in the present exemplary embodiment, regenerative braking forces of the left and right wheels 22L, 22R are independently controlled, and, in the case of FIG. 7, a braking force BL of the left wheel 22L is reduced, and a braking force BR of the right wheel 22R is increased, whereby an anti-yaw moment (refer to arrow A) is generated. Consequently, the bending angle can be made to be the required bending angle, and the towing vehicle 12 can be caused follow the target trajectory T2 (in other words, an actual trajectory Tb of the towing vehicle 12 can be made to be along the target trajectory T2).

As described above, according to the present exemplary embodiment illustrated in FIG. 1 to FIG. 7, it is possible to suppress occurrence of a jackknife phenomenon even if the towing vehicle 12 is braked in a state in which the connecting section 16 between the towing vehicle 12 and the towed vehicle 14 is bent at a bending angle.

### Supplementary Explanation of Exemplary Embodiment

It should be noted that, although the towing vehicle 12 is an autonomous driving vehicle that does not include a driver's seat in the above-described exemplary embodiment, the towing vehicle may be a vehicle capable of autonomous driving that includes a driver's seat. Further, in the above-described exemplary embodiment, the towing vehicle 12 is configured to travel within a factory to be used for transportation of components and the like, but the towing vehicle may travel in an area other than within a factory to be used to deliver products and the like other than components.

Further, in the above-described exemplary embodiment, the calculation section 504 calculates the target total braking force based on the detection results from the wheel speed sensors 34L, 34R and the travel plan of the towing vehicle 12, and, when calculating the left-right difference in braking force of the towing vehicle 12 so as to suppress the yaw moment estimated by the yaw moment estimation section 503, calculates the left and right braking forces of the towing vehicle 12 without changing the target total braking force, but the calculation section can also be configured to calculate the left and right braking forces of the towing vehicle 12 by appropriately changing the target total braking force in consideration of the peripheral situation including, for example, a weather situation and a traffic situation, or the like.

Furthermore, in the above-described exemplary embodiment, the control section 505 controls the left and right braking forces of the towing vehicle 12 so that the change gradient, which is the change amount per unit time of each of the left and right braking forces of the towing vehicle 12, does not exceed the preset upper limit gradient, and, although such a configuration is preferable, a configuration may also be adopted in which the upper limit gradient is not set, in consideration of a travel course or the like of the connected vehicles to which the vehicle control device is applied.

Further, although the braking and driving section is configured by the in-wheel motors 32L, 32R in the above-described exemplary embodiment, the braking and driving section may be, for example, a braking and driving section in which a motor and a friction brake device cooperate to independently apply braking and driving forces to the left and right wheels 22L, 22R of the towing vehicle 12, respectively.

Furthermore, in the above-described exemplary embodiment, the angle detection section is configured by the rotation angle sensor 38 provided at the connecting section 16 illustrated in FIG. 1, but the angle detection section may be, for example, an angle detection section including an image capture camera provided at a rear surface of the vehicle body 20 of the towing vehicle 12, and an image detection device that detects the bending angle of the connecting section 16 between the towing vehicle 12 and the towed vehicle 14 from image data captured by the image capture camera.

It should be noted that the respective processing carried out by the CPU 50A illustrated in FIG. 2 reading and executing software (a program) in the above-described exemplary embodiment may be executed by various types of processors other than a CPU. Such processors include programmable logic devices (PLD) that allow circuit configuration to be modified post-manufacture, such as a field-programmable gate array (FPGA) or the like, and dedicated electric circuits, which are processors including a circuit configuration that has been custom-designed to execute specific processing, such as an application specific integrated circuit (ASIC) or the like. Further, the respective processing may be executed by any one of these various types of processors, or may be executed by a combination of two or more of the same type or different types of processors (such as, for example, plural FPGAs, a combination of a CPU and an FPGA, or the like). Furthermore, the hardware structure of these various types of processors is, more specifically, an electric circuit combining circuit elements such as semiconductor elements or the like.

Further, the program described in the above exemplary embodiment may be provided in a format recorded on a recording medium such as a compact disc read only memory (CD-ROM), a digital versatile disc read only memory (DVD-ROM), a universal serial bus (USB) memory, or the like. Alternatively, the program may be provided in a format that is downloaded from an external device via a network.

It should be noted that the above-described exemplary embodiment and modified examples may be implemented in appropriate combinations.

Although an example of the present disclosure has been described above, the present disclosure is not limited to the above description, and it will be obvious that various other modifications may the implemented within a range that does not depart from the spirit of the present disclosure.

What is claimed is:

1. A vehicle control device that is applied to connected vehicles in which a towed vehicle is connected to a towing vehicle, the vehicle control device comprising:
a braking and driving section configured to independently apply braking and driving forces to left and right wheels of the towing vehicle, respectively;
a braking and driving force detection section configured to detect braking and driving forces of respective wheels of the towing vehicle;
a mass estimation section configured to estimate a mass of the towed vehicle;
an angle detection section configured to detect a bending angle of a connecting section between the towing vehicle and the towed vehicle;
a yaw moment estimation section configured to estimate a yaw moment with respect to the towing vehicle during braking of the towing vehicle, using a detection result of the angle detection section and an estimation result of the mass estimation section;
a calculation section configured to calculate a left-right difference in braking force of the towing vehicle so as to suppress the yaw moment estimated by the yaw moment estimation section; and
a control section configured to control left and right braking forces of the towing vehicle, by using a detection result of the braking and driving force detection section, based on a calculation result of the calculation section.

2. The vehicle control device according to claim 1, further comprising a wheel speed detection section configured to detect respective wheel speeds of the towing vehicle,
wherein the calculation section calculates a target total braking force based on a detection result of the wheel speed detection section and a travel plan of the towing vehicle, and calculates the left and right braking forces of the towing vehicle without changing the target total braking force when calculating the left-right difference in braking force of the towing vehicle so as to suppress the yaw moment estimated by the yaw moment estimation section.

3. The vehicle control device according to claim 1, wherein the control section controls the left and right braking forces of the towing vehicle such that a change gradient, which is a change amount per unit time of each of the left and right braking forces of the towing vehicle, does not exceed a preset upper limit gradient.

4. A control method for a vehicle control device that is applied to connected vehicles in which a towed vehicle is connected to a towing vehicle, the vehicle control device comprising:
a braking and driving section configured to independently apply braking and driving forces to left and right wheels of the towing vehicle, respectively;
a braking and driving force detection section configured to detect braking and driving forces of respective wheels of the towing vehicle;
a mass estimation section configured to estimate a mass of the towed vehicle; and
an angle detection section configured to detect a bending angle of a connecting section between the towing vehicle and the towed vehicle,
the control method comprising:
estimating a yaw moment with respect to the towing vehicle during braking of the towing vehicle, using a detection result of the angle detection section and an estimation result of the mass estimation section;
calculating a left-right difference in braking force of the towing vehicle so as to suppress the estimated yaw moment; and
controlling left and right braking forces of the towing vehicle, by using a detection result of the braking and driving force detection section, based on a calculation result of calculating the left-right difference in braking force.

5. A non-transitory computer-readable storage medium storing a control program for a vehicle control device, the control program being executable by a computer included in the vehicle control device to perform information processing, the vehicle control device being applied to connected vehicles in which a towed vehicle is connected to a towing vehicle, and the vehicle control device comprising:
a braking and driving section configured to independently apply braking and driving forces to left and right wheels of the towing vehicle, respectively;
a braking and driving force detection section configured to detect braking and driving forces of respective wheels of the towing vehicle;
a mass estimation section configured to estimate a mass of the towed vehicle; and
an angle detection section configured to detect a bending angle of a connecting section between the towing vehicle and the towed vehicle,
the information processing comprising:
estimating a yaw moment with respect to the towing vehicle during braking of the towing vehicle, using a detection result of the angle detection section and an estimation result of the mass estimation section;
calculating a left-right difference in braking force of the towing vehicle so as to suppress the estimated yaw moment; and
controlling left and right braking forces of the towing vehicle, by using a detection result of the braking and driving force detection section, based on a calculation result of calculating the left-right difference in braking force.
